(19) United States
(12) Patent Application Publication
(10) Pub. No.: US 2013/0249420 A1
(43) Pub. Date: Sep. 26, 2013

(54) LED DRIVING SYSTEM AND METHOD

(71) Applicants: YONG-LONG LEE, Jhongli City (TW); CHENG-HUNG TSAI, Jhongli City (TW)

(72) Inventors: YONG-LONG LEE, Jhongli City (TW); CHENG-HUNG TSAI, Jhongli City (TW)

(73) Assignee: AMPOWER TECHNOLOGY CO., LTD., Jhongli City (TW)

(21) Appl. No.: 13/532,808

(22) Filed: Jun. 26, 2012

(30) Foreign Application Priority Data
Mar. 23, 2012 (TW) 101109967

(51) Int. Cl. H05B 37/02

(52) U.S. Cl. 315/192

(57) ABSTRACT

A light emitting diode (LED) driving system includes a sampling circuit, a control circuit, a PWM controller circuit, a DC/DC converter and a current balance circuit. The sampling circuit detects voltage of cathodes of LED strings of a LED array. The control circuit generates and outputs a control signal according to the minimum voltage of the cathodes of rest LED strings except LED string with the minimum cathode voltage, if the minimum voltage is in an expected voltage range and a difference between the maximum voltage of the cathodes of the LED strings and the minimum voltage of the cathodes of the LED strings is greater than a threshold. The PWM controller circuit generates and outputs PWM signals according to the control signal, to control the DC/DC converter generate and output suitable direct current voltage to drive the LED array. The current balance circuit comprises a plurality of switches.

### BACKGROUND

1. Technical Field

The disclosure relates to backlight driving systems, and particularly to a light emitting diode (LED) driving system and method of a display device.

2. Description of Related Art

Light emitting diodes (LEDs) with intrinsic power saving performance are increasingly utilized as display backlights. As a good display requires smooth LED backlighting, switches are correspondingly connected to LED strings respectively in series, to balance current flowing through each LED string. Usually, drivers of the LED strings provide sufficient voltage that satisfies voltage drop requirements of the LED strings to make the LED strings have sufficient current. However, because each LED may have different characteristic, different LED strings may have different voltage drops. A switch connected to one of the LED strings with the minimum voltage drop accordingly has the maximum voltage drop, which induce great power loss and thermal stress.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic diagram of one embodiment of a light emitting diode driving system as disclosed.

FIG. 2 is a schematic diagram of another embodiment of a light emitting diode driving system as disclosed.

FIG. 3 is a flowchart of one embodiment of a light emitting diode driving method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

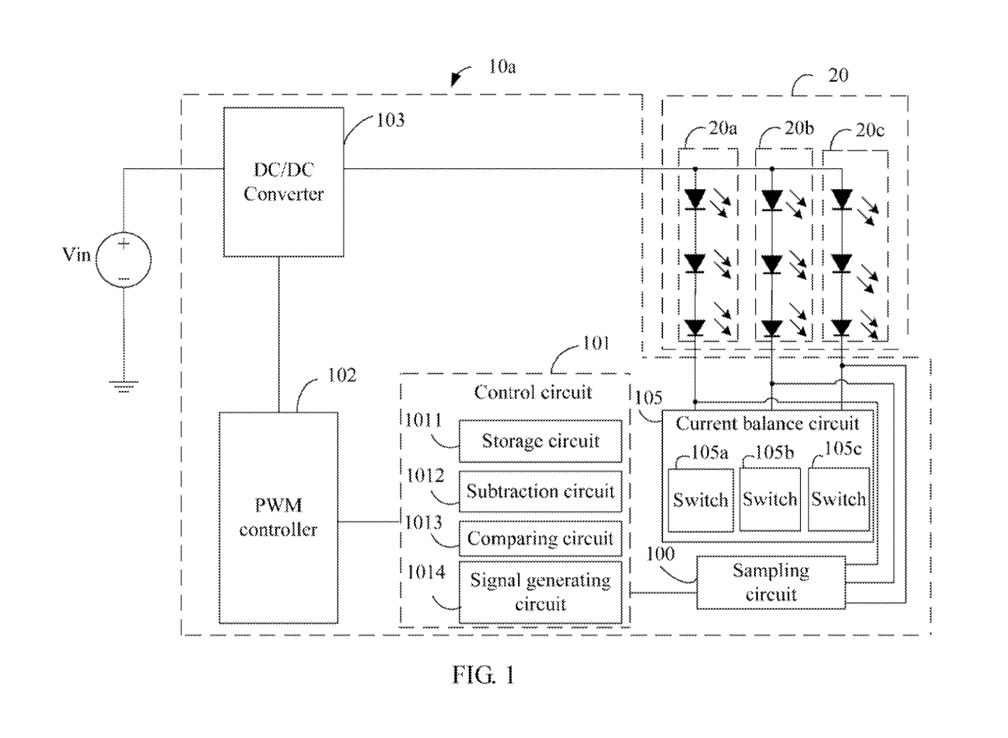

FIG. 1 is a schematic diagram of one embodiment of a light emitting diode (LED) driving system 10a as disclosed. In the embodiment, the LED driving system 10a comprises a sampling circuit 100, a control circuit 101, a pulse width modulation (PWM) controller 102, a DC/DC converter 103, and a current balance circuit 105, to drive a LED array 20. In the embodiment, the LED array 20 comprises a plurality of LED strings which comprise LED strings 20a, 20b, 20c connected in parallel, and each of the LED strings 20a, 20b, 20c comprises a plurality of LEDs connected in series forwardly. An anode of each LED string 20a, 20b, 20c is an anode of the first LED of each LED string 20a, 20b, 20c, and a cathode of each LED string 20a, 20b, 20c is a cathode of the last LED of each LED string 20a, 20b, 20c. Accordingly, an anode of the LED array 20 is a common node of the anodes of the LED strings 20a, 20b, 20c. The DC/DC converter 103 is connected to an external power supply Vin, the PWM controller 102 and the LED array 20, to convert external power supplied by the external power supply Vin into suitable direct current voltage according to PWM signals generated by the PWM controller 102, to drive the LED array 20.

In the embodiment, the current balance circuit 105 is connected to cathodes of the LED strings 20a, 20b, 20c of the LED array 20, and balances current flowing through the LED strings 20a, 20b, 20c. In the embodiment, the current balance circuit 105 comprises a plurality of switches 105a, 105b, 105c correspondingly connected to the cathodes of the LED strings 20a, 20b, 20c. In the embodiment, the number of the switches 105a, 105b, 105c is the same to that of the LED strings 20a, 20b, 20c. In one example, the number of the switches 105a, 105b, 105c may be three, and the number of LED strings 20a, 20b, 20c may also be three. In the embodiment, the switches 20a, 20b, 20c are bipolar junction transistors or field effect transistors.

The sampling circuit 100 is connected to the cathodes of the LED strings 20a, 20b, 20c, and detects voltage of the cathodes of the LED strings 20a, 20b, 20c, and feeds back the voltages of the cathodes of the LED strings 20a, 20b, 20c to the control circuit 101. In the embodiment, the sampling circuit 100 detects the voltages of the cathodes of the LED strings 20a, 20b, 20c continuously.

The control circuit 101 is connected between the sampling circuit 100 and the PWM controller 102, to generate and output a control signal to the PWM controller 102, to control a duty cycle of the PWM signals. In the embodiment, the control circuit 101 comprises a storage circuit 1011, a subtraction circuit 1012, a comparing circuit 1013 and a signal generating circuit 1014. The storage circuit 1011 stores an expected voltage range of the voltages of the cathodes of the LED strings 20a, 20b, 20c and a threshold voltage difference. In the embodiment, the expected voltage range is defined as a stabilization range of the LED driving system 10a, and can be enacted according to experimental data by users, such as [0.1, 0.25] volt (V). The threshold voltage difference is the maximum voltage difference between the switches 105a, 105b, 105c that can be supported, such as 0.3 volts (V).

In the embodiment, the comparing circuit 1013 compares the voltages of the cathodes of the LED strings 20a, 20b, 20c, to retrieve a maximum and a minimum voltage of the cathodes of the LED strings 20a, 20b, 20c, and determines whether the minimum voltage of the cathodes of the LED strings 20a, 20b, 20c fall within the expected voltage range. The subtraction circuit 1012 subtracts the minimum voltage of the cathodes of the LED strings 20a, 20b, 20c from the maximum voltage of the cathodes of the LED strings 20a, 20b, 20c to retrieve a difference between the maximum voltage and the minimum voltage of the cathodes of LED strings 20a, 20b, 20c when the minimum voltage of the cathodes of the LED strings 20a, 20b, 20c is within expected voltage range, and calculates a difference between the minimum voltage of the cathodes of the LED strings 20a, 20b, 20c and the expected voltage range when the minimum voltage of the cathode of the LED strings 20a, 20b, 20c is not within the expected voltage range. The comparing circuit 1013 also determines whether the difference between the maximum voltage and the minimum voltage of the cathodes of the LED strings 20a, 20b, 20c is greater than the threshold, and elects a minimum voltage of the cathodes of rest of LED strings 20a, 20b, 20c except the LED string with the minimum cathode voltage, and continuously determines whether the minimum voltage of the cathodes of the rest of the LED strings 20a, 20b, 20c fall within the expected voltage range. The signal generating circuit 1014 generates and outputs the control signal according to the difference between the minimum voltage of the cathodes of the LED strings 20a, 20b, 20c and the expected voltage range when the minimum voltage of the cathodes of the LED strings 20a, 20b, 20c is not within the expected voltage range, and generates and outputs the control signal according to the minimum voltage when the difference between the maximum voltage of the cathodes of the LED strings 20a, 20b, 20c and the minimum voltage of the cathodes of the LED strings 20a, 20b, 20c is not greater than the threshold.

In the embodiment, the comparing circuit 1013 compares the voltage of cathodes of the LED strings 20a, 20b, 20c to retrieve the maximum and the minimum voltage of the cathodes of the LED strings 20a, 20b, 20c, and determines whether the minimum voltage of the cathodes of the LED strings 20a, 20b, 20c fall within the expected voltage range to determine whether the LED driving system 10 is stable. If the minimum voltage of the cathodes of the LED strings 20a, 20b, 20c is within the expected voltage range, the LED driving system 10 is stable. If the minimum voltage of the cathodes of the LED strings 20a, 20b, 20c is not within the expected voltage range, the LED driving system 10 is unstable, and the direct current voltage output by the DC/DC converter 103 is required to adjust. In the embodiment, the subtraction circuit 1012 calculates the difference between the minimum voltage of the cathodes of the LED strings 20a, 20b, 20c and the expected voltage range, which is the difference between the minimum value of the expected voltage range and the minimum voltage of the cathodes of the LED strings 20a, 20b, 20c when the minimum voltage of the cathodes of the LED strings 20a, 20b, 20c is less than the minimum value of the expected voltage range. The subtraction circuit 1012 calculates the difference between the minimum voltage of the cathodes of the LED strings 20a, 20b, 20c and the expected voltage range, which is the difference between the minimum voltage of the cathodes of the LED strings 20a, 20b, 20c and the maximum value of the expected voltage range when the minimum voltage of the cathodes of the LED strings 20a, 20b, 20c is greater than the maximum value of the expected voltage range.

In the embodiment, the signal generating circuit 1014 generates and outputs the control signal to the PWM controller 102 according to the difference between the minimum voltage of the cathodes of the LED strings 20a, 20b, 20c and the expected voltage range when the minimum voltage of the cathodes of the LED strings 20a, 20b, 20c is not within the expected voltage range. The signal generating circuit 1014 generates and outputs the control signal with a first duty cycle to control the PWM controller 102 to generate and output the PWM signals with a first duty cycle, and to control the DC/DC converter 103 to generate and output a first direct current voltage to make current and light of the LED array 20 decrease, when the minimum voltage of the cathodes of the LED strings 20a, 20b, 20c is less than the minimum value of the expected voltage range. The signal generating circuit 1014 generates and outputs the control signal with a second duty cycle, to control the PWM controller 102 to generate and output the PWM signals with a second duty cycle, thus the DC/DC converter 103 generates and outputs a second direct current voltage, to make current and light of the LED array 20 increase when the minimum voltage is greater than the maximum value of the expected voltage range. In the embodiment, the first duty cycle is less than the second duty cycle, correspondingly the first direct current voltage is less than the second direct current voltage.

In the embodiment, when the minimum voltage of the cathodes of the LED strings 20a, 20b, 20c is within the expected voltage range, the subtraction circuit 1012 retrieves the difference between the maximum voltage of the cathodes of the LED strings 20a, 20b, 20c and the minimum voltage of the cathodes of the LED strings 20a, 20b, 20c, and then the difference between the maximum voltage of the cathodes of the LED strings 20a, 20b, 20c and the minimum voltage of the cathodes of the LED strings 20a, 20b, 20c is compared with the threshold by the comparing circuit 1013. When the difference between the maximum voltage of the cathodes of the LED strings 20a, 20b, 20c and the minimum voltage of the cathodes of the LED strings 20a, 20b, 20c is greater than the threshold, the comparing circuit 1013 elects the minimum voltage of the cathodes of the rest of the LED strings except the LED string with the minimum cathode voltage, and continuously determines whether the minimum voltage of the cathodes of the rest of the LED strings fall within the expected voltage range. The signal generating circuit 1014 generates and outputs the control signal according to the minimum voltage of the cathodes of the LED strings 20a, 20b, 20c when the difference between the maximum voltage of the cathodes of the LED strings 20a, 20b, 20c and the minimum voltage of the cathodes of the LED strings 20a, 20b, 20c is not greater than the threshold.

The signal generating circuit 1014 generates and outputs the control signal with a constant duty cycle, to control the PWM controller 102 to generate and output the PWM signals with a constant duty cycle too, thus the DC/DC converter 103 generates and outputs constant direct current voltage to drive the LED array 20 when the difference between the maximum voltage of the cathodes of the LED strings 20a, 20b, 20c and the minimum voltage of the cathodes of the LED strings 20a, 20b, 20c is not greater than threshold.

In the embodiment, the control signal and the PWM signals are both square-wave signals.

In the embodiment, the control circuit 101 elects the minimum voltage of the cathodes of the rest of the LED strings except the LED string with the minimum cathode voltage, and continuously determines whether the minimum voltage of the cathodes of the rest of the LED strings fall within the expected voltage range, when the minimum voltage of the cathodes of the LED strings 20a, 20b, 20c of the LED array 20 is within the expected voltage range and the difference between the maximum voltage of the cathodes of the LED strings 20a, 20b, 20c and the minimum voltage of the cathodes of the LED strings 20a, 20b, 20c is greater than the threshold. When the minimum voltage of the cathodes of the rest of the LED strings is within the expected voltage range, and the difference between the maximum voltage of the cathodes of the rest of the LED strings and the minimum voltage of the cathodes of the rest of the LED stings is greater than the threshold, the control circuit 101 not elects the minimum voltage of the cathodes of rest of the rest of the LED strings except the LED string with the minimum cathode voltage until the minimum voltage of the cathodes of the rest of the LED strings 20a, 20b, 20c is not within expected voltage range or the difference between the maximum voltage of the cathodes of the rest of the LED strings 20a,20b, 20c and the minimum voltage of the cathodes of the rest of the LED strings 20a,20b, 20c is not greater than the threshold. When the minimum voltage of the cathodes of the rest of the LED strings 20a, 20b, 20c is not within the expected voltage range, the control circuit 101 adjusts the duty cycle of the control signal according to the difference between the minimum voltage of the cathodes of the rest of the LED strings 20a, 2b, 20c and the expected voltage range, thus to adjust the duty cycle of the PWM signals, and to adjust the direct current voltage outputted to the LED array 20.

When the difference between the maximum voltage of the cathodes of the LED strings 20a, 20b, 20c and the minimum voltage of the cathodes of the LED strings 20a, 20b, 20c is not greater than the threshold, the control circuit 101 generates and outputs the control signal with the first duty to control the PWM controller 102 to generate and output the PWM signals with the first duty cycle, and to control the DC/DC converter 103 generate and output the first direct current voltage to make current and light of the LED array 20 decrease.

The LED string that has the minimum cathode voltage means the LED string has the maximum voltage drop, so the control circuit 101 elects the minimum voltage of the cathodes of the rest LED strings except the LED string with the minimum cathode voltage, which avoids adjusting the duty cycle of the PWM signals according to the LED string with the maximum voltage drop, and reduces the direct current voltage outputted by the DC/DC converter 103, and then reduces voltage drop of the switches 105a, 105b, 105c of the current balance circuit 105, to improve the thermal stress problem caused by the switches 105a, 105b, 105c with a great power loss.

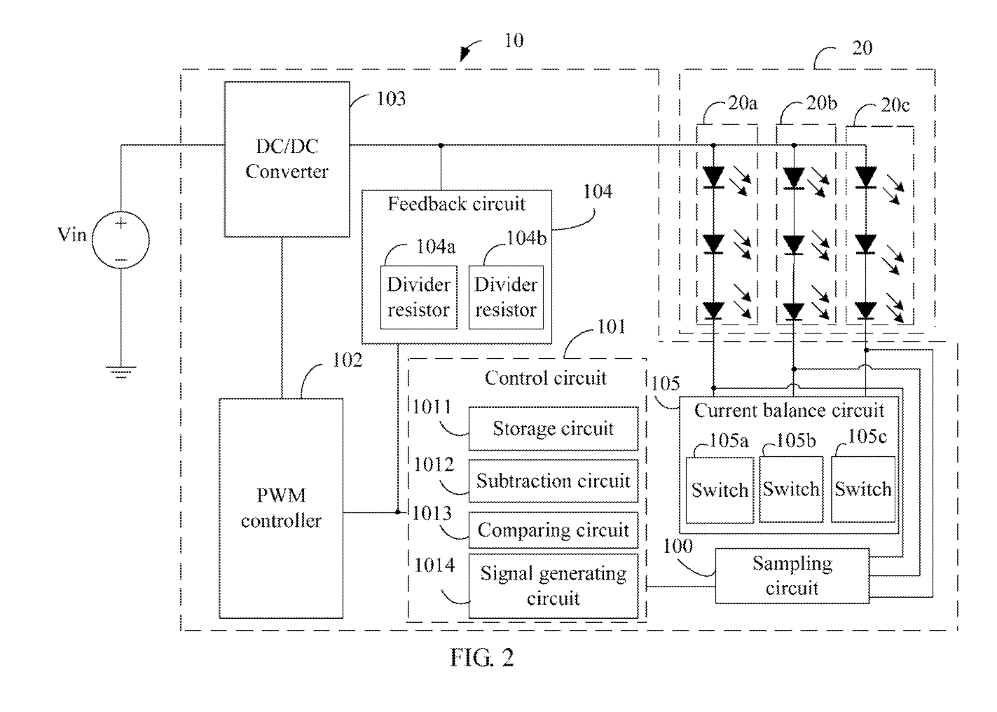

FIG. 2 is a schematic diagram of another embodiment of the LED driving system 10a as disclosed. The difference between the LED driving system 10a and the LED driving system 10 is that the LED driving system 10a further comprises a feedback circuit 104.

In the embodiment, the feedback circuit 104 is connected to an output of the DC/DC converter 103, to receive the direct current voltage outputted by the DC/DC converter 103, and to output a feedback signal to the PWM controller 102 according to the direct current voltage, to adjust the duty cycle of the PWM signals. In the embodiment, the feedback signal and the control signal adjust the duty cycle of the PWM signals together, and to adjust the direct current voltage outputted by the DC/DC converter 103. In the embodiment, the feedback plays a chief role, and the control signal plays a secondary role in adjusting the duty cycle of the PWM signals.

In the embodiment, the feedback circuit 104 comprises two divider resistor 104a, 104b connected between the output of the DC/DC converter 103 and ground. The two divider resistor 104a, 104b connects in serials each other, and the PWM control circuit 102 is connected to a common point of the two divider resistor 104a, 104b. In alternative embodiment, the feedback circuit 104 comprises a coil too, to output the feedback signal to the PWM controller 102 according to the direct current voltage, to adjust the duty cycle of the PWM signals.

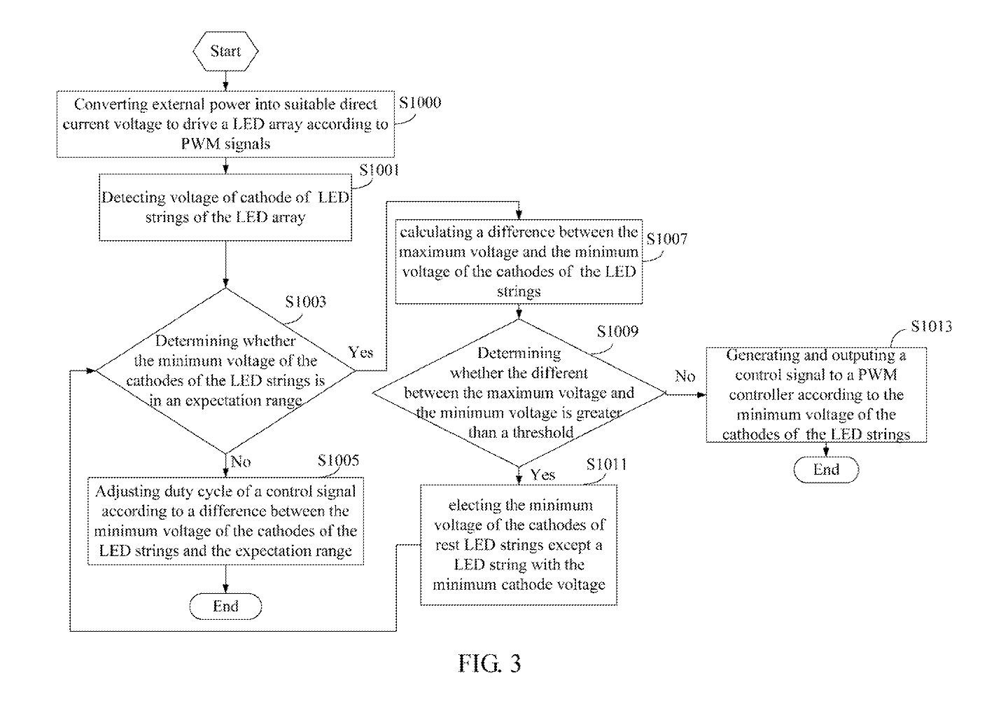

FIG. 3 is a flowchart of one embodiment of a LED driving method. Firstly, in step S1000, the DC/DC converter circuit 103 converts the external power supplied by the external power supply Vin into the suitable direct current voltage, to drive the LED array 20. In step S1001, the sampling circuit 100 detects the voltages of the cathodes of the LED strings 20a, 20b, 20c, and feedbacks the voltages of the cathodes of the LED strings 20a, 20b, 20c to the control circuit 101. In step S1003, the control circuit 101 compares the voltages of the cathodes of the LED strings 20a, 20b, 20c, and retrieves the maximum voltage of the cathodes of the LED strings 20a, 20b, 20c and the minimum voltage of the cathodes of the LED strings 20a, 20b, 20c. The control circuit 101 determines whether the minimum voltage of the cathodes of the LED strings 20a, 20b, 20c fall within the expected voltage range, to determine whether the LED driving system is stable. If the minimum voltage is within the expected voltage range, the LED driving system is stable. If the minimum voltage is not within the expected voltage range, the LED driving system is unstable and the direct current voltage output by the DC/DC converter 103 is required to adjust. So if the minimum voltage of the cathodes of the LED strings 20a, 20b, 20c is not within the expected voltage range, in step S1005, the control circuit 101 adjusts the duty cycle of the control signal according to the difference between the minimum voltage of the cathodes of the LED strings 20a, 20b, 20c and the expected voltage range to adjust the duty cycle of the PWM signals generated by the PWM controller 102, and to adjust the direct current voltage outputting to the LED array 20.

If the minimum voltage of the cathode of the LED strings 20a, 20b, 20c is within the expected voltage range, in step S1004, the control circuit 101 counts the difference between the maximum voltage and the minimum voltage. In step S1009, the control circuit 101 determines whether the difference between the maximum voltage and the minimum voltage is greater than the threshold, to determine whether the voltage drop of the switches 105a, 105b, 105c causes the thermal stress problem. If the difference between the maximum voltage of the cathodes of the LED strings 20a, 20b, 20c and the minimum voltage of the cathodes of the LED strings 20a, 20b, 20c is greater than the threshold, into step S1011 to avoid the voltage drop of the switches 105a, 105b, 105c causes the thermal stress problem. In step S1011, the control circuit 1011 elects the minimum voltage of the cathodes of the rest LED strings except the LED string with the minimum cathode voltage, and repeatedly in step S1003. If the difference between the maximum voltage of the cathodes of the LED strings 20a, 20b, 20c and minimum voltage of the cathodes of the LED strings 20a, 20b, 20c is not greater than the threshold, which means the voltage drop of the switches 105a, 105b, 105c not cause the thermal stress problem, in step S1013, the control circuit 101 generates and outputs the control signal to the PWM controller 102 correspondingly. The feedback circuit 104 generates and outputs the feedback signal according to the direct current voltage outputted by the DC/DC converter 103, to adjust the duty cycle of the PWM signals.

The LED driving system 10 and the LED driving method elects the minimum voltage of the cathodes of the rest LED strings except the LED string witch the minimum cathode voltage, when the minimum voltage of the cathode is within the expected voltage range and the difference between the maximum voltage of the cathodes of the LED strings 20a, 20b, 20c and the minimum voltage of the cathodes of the LED strings 20a, 20b, 20c is greater than the threshold. Thus, the LED driving system 10 and the LED driving method adjusts the duty cycle of the control signal according to the minimum voltage of the cathodes of the LED strings 20a, 20b, 20c, to control the duty cycle of the PWM signals outputted by the PWM controller 102, and to control the direct current voltage outputting to the LED array 20, to improve the thermal stress problem caused by the power loss of the switches 105a, 105b, 105c.

The foregoing disclosure of the various embodiments has been presented for purposes of illustration and description. It is not intended to be exhaustive or to limit the invention to the precise forms disclosed. Many variations and modifications of the embodiments described herein will be apparent to one of ordinary skill in the art in the light of the above disclosure. The scope of the invention is to be defined only by the claims appended hereto and their equivalents.

What is claimed is:

1. A light emitting diode (LED) driving method, driving a LED array comprising a plurality of LED strings connected in parallel, each LED string having an anode and a cathode, the LED driving method comprising:
converting external power supplied by an external power supply into direct current voltage to drive the LED array according to PWM signals outputted by a PWM controller, and using a current balance circuit to balance current flowing through the LED strings;
detecting voltages of cathodes of the LED strings that comprises a maximum voltage and a minimum voltage of the cathodes of the LED strings;
determining whether the minimum voltage of the cathodes of the LED strings falls within an expected voltage range, wherein the LED string with the minimum cathode voltage is referred to as a first LED string, the determining process including:
if the minimum voltage of the cathodes of the LED strings is within the expected voltage range, comparing a difference between the maximum voltage of the cathodes of the LED strings and the minimum voltage of the cathodes of the LED strings with a threshold voltage difference;
if the difference between the maximum voltage of the cathodes of the LED strings and the minimum voltage of the cathodes of the LED strings is greater than the threshold voltage difference, electing the minimum voltage of cathodes of the LED strings excluding the first LED string and determining whether a minimum voltage of cathodes of the rest of the LED strings fall within the expected voltage range; and
if the difference between the maximum voltage of the cathodes of the LED strings and the minimum voltage of the cathodes of the LED strings is not greater than the threshold, outputting a control signal to the PWM controller according to the minimum voltage of the cathodes of the LED strings.

2. The LED driving method of claim 1, further comprising:
if the minimum voltage of the cathodes of the LED strings is not within the expected voltage range, adjusting duty cycle of the control signal according to a difference between the minimum voltage of the cathodes of the LED strings and the expected voltage range, to adjust duty cycle of the PWM signals outputted by the PWM controller.

3. The LED driving method of claim 2, wherein the step of if the minimum voltage of the cathodes of the LED strings is not within the expected voltage range, adjusting duty cycle of the control signal according to the difference between the minimum voltage of the cathodes of the LED strings and the expected voltage range, to adjust duty cycle of the PWM signals outputted by the PWM controller, the adjusting duty cycle of the PWM signals outputted by the PWM controller further comprises:
if the minimum voltage of the cathodes of the LED strings is less than the minimum value of the expected voltage range, outputting the control signal with a first duty cycle to the PWM controller; and
if the minimum voltage of the cathodes of the LED strings is greater than the maximum value of the expected voltage range, outputting the control signal with a second duty cycle to the PWM controller.

4. The LED driving method of claim 1, wherein the step of comparing the difference between the maximum voltage of the cathodes of the LED strings and the minimum voltage of the cathodes of the LED strings with the threshold comprises:
retrieving the maximum voltage of the cathodes of the LED strings and the minimum voltage of the cathodes of the LED strings; and
calculating the difference between the maximum voltage of the cathodes of the LED strings and the minimum voltage of the cathodes of the LED strings.

5. A light emitting diode (LED) driving system, driving a LED array comprising a plurality of LED strings connected to each other in parallel, each LED string has an anode and cathode, the LED driving system comprising:
a DC/DC converter operable to convert external power supplied by an external power supply into suitable direct current voltage to drive the LED array;
a sampling circuit connected to cathodes of the LED strings, and operable to detect voltage of cathodes of the LED strings;
a control circuit connected to the sampling circuit, the control circuit comprising:
a comparing circuit, comparing the voltage of the cathode of the LED strings to retrieve the maximum voltage of the cathodes of the LED strings and the minimum voltage of the cathodes of the LED strings, and determining whether the minimum voltage of the cathodes of the LED strings fall within an expected voltage range;
a subtraction circuit, calculating a difference between the maximum voltage of the cathodes of the LED strings and the minimum voltage of the cathodes of the LED strings when the minimum voltage of the cathodes of the LED strings is within the expected voltage range, the comparing circuit further determining whether the difference between the maximum voltage of the cathodes of the LED strings and the minimum voltage of the cathodes of the LED strings is greater than a threshold, and electing the minimum voltage of the cathodes of rest LED strings except a LED string with the minimum cathode voltage, to determine whether the minimum voltage of the cathodes of the rest LED strings fall within the expected voltage range; and
a signal generating circuit, generating and outputting a control signal according to the minimum voltage of the cathodes of the LED strings if the difference between the maximum voltage of the cathodes of the LED strings and the minimum voltage of the cathodes of the LED strings is not greater than the threshold; and
a PWM controller, connected to the control circuit, the PWM controller generating and outputting PWM signals according to the control signal; and
a current balance circuit, connected to the cathodes of the LED strings of the LED array, the current balance circuit balancing current flowing through the LED strings, the current balance circuit comprising a plurality of switches.

6. The LED driving system of claim 5, wherein the switches comprises bipolar junction transistors, the bipolar junction transistors balancing the current flowing through the LED strings.

7. The LED driving system of claim 5, further comprising:
a feedback circuit connected to an output of the DC/DC converter, the feedback circuit generating and outputting a feedback signal to the PWM controller to adjust duty cycle of the PWM signals.

8. The LED driving system of claim 5, wherein the subtraction circuit further calculates a difference between the minimum voltage of the cathodes of the LED strings and the expected voltage range if the minimum voltage of the cathodes of the LED strings is not within the expected voltage range.

9. The LED driving system of claim 8, wherein the signal generating circuit generates and outputs the control signal according to the difference between the minimum voltage of the cathodes of the LED strings and the expected voltage range if the minimum voltage of the cathodes of the LED strings is not within the expected voltage range.

10. The LED driving method of claim 9, wherein the signal generating circuit outputs the control signal with a first duty cycle to the PWM controller if the minimum voltage of the cathodes of the LED strings is less than the minimum value of the expected voltage range, and outputs the control signal with a second duty cycle to the PWM controller if the minimum voltage of the cathodes of the LED strings is greater than the maximum value of the expected voltage range.

11. The LED driving system of claim 5, wherein the control circuit comprises:
a storage circuit, storing the expected voltage range and the threshold.

12. A light emitting diode (LED) driving method, driving a LED array comprising a plurality of LED strings connected to each other in parallel, the LED driving method comprising:
converting external power supplied by an external power supply into suitable direct current voltage to drive the LED array according to PWM signals outputted by a PWM controller, and using a current balance circuit to balance current flowing through the LED strings;
detecting the maximum voltage of the cathodes of the LED strings and the minimum voltage of the cathodes of the LED strings;
comparing a difference between the maximum voltage of the cathodes of the LED strings and the minimum voltage of the cathodes of the LED strings with a threshold if the minimum voltage of the cathodes of the LED strings is within an expected voltage range;
if the difference between the maximum voltage of the cathodes of the LED strings and the minimum voltage of the cathodes of the LED strings is greater than the threshold, electing the minimum voltage of cathodes of rest LED strings except a LED string with the minimum cathode voltage, to continuously determine whether the minimum voltage of cathodes of the rest LED strings fall within the expected voltage range, and compare a difference between the maximum voltage of the cathodes of the LED strings and the minimum voltage of the cathodes of the rest LED strings with the threshold, to retrieve the minimum voltage whose difference with the maximum voltage of the cathodes of the LED strings is less than the threshold; and
generating and outputting a control signal to the PWM controller according to the minimum voltage the difference of which with the maximum voltage of the cathodes of the LED strings is less than the threshold.

13. The LED driving method of claim 12, further comprising:
if the minimum voltage of the cathodes of the LED strings is not within the expected voltage range, adjusting duty cycle of the control signal according to a difference between the minimum voltage of the cathodes of the LED strings and the expected voltage range, to adjust duty cycle of the PWM signals outputted by the PWM controller.

14. The LED driving method of claim 13, wherein the step of if the minimum voltage of the cathodes of the LED strings is not within the expected voltage range, adjusting duty cycle of the control signal according to the difference between the minimum voltage of the cathodes of the LED strings and the expected voltage range, to adjust duty cycle of the PWM signals outputted by the PWM controller further comprises:
if the minimum voltage of the cathodes of the LED strings is less than the minimum value of the expected voltage range, outputting the control signal with a first duty cycle to the PWM controller; and
if the minimum voltage of the cathodes of the LED strings is greater than the maximum value of the expected voltage range, outputting the control signal with a second duty cycle to the PWM controller.
